(19) United States
(12) Patent Application Publication
(10) Pub. No.: US 2019/0174772 A1
(43) Pub. Date: Jun. 13, 2019

(54) Pizza, pie, and cake cutter

(71) Applicant: JaRon Lynelle Walters, Indianapolis, IN (US)

(72) Inventor: JaRon Lynelle Walters, Indianapolis, IN (US)

(21) Appl. No.: 16/172,733

(22) Filed: Oct. 27, 2018

Related U.S. Application Data
(63) Continuation of application No. 62/707,277, filed on Oct. 27, 2017.

(51) Int. Cl. A21C 15/04; B26D 3/24

(52) U.S. Cl. CPC A21C 15/04; B26D 3/24

(57) ABSTRACT

A multifunction cutter that allows the user to easily and consistently cut even slices of pizza, pie, or cake. This cutter comes with 3 major frames/platforms that are connected and supported via two elongated poles on the lateral sides of the cutter. Between the middle and bottom row, located around the poles are a pair of springs which allow the multifunctional cutter to retract after each cut. The base of the multifunction cutter has a platform that can rotate to create addition equal slices.

### REFERENCE TO RELATED APPLICATIONS

This is a continuation of application Ser. No. 62/702,277 filed on Oct. 27, 2017 entitled “Perfect Piece,” which is incorporated herein by reference.

### BACKGROUND OF THE INVENTION

### Field of the Invention

This invention generally relates to a multi-functional cutter for foodstuff, and more particularly to improve cutting distribution of uniform slices for pizza, pie, and cake.

### Related Art

Pizza, pie, and cake cutters are used every day and come in multiple variations. Sports teams, private and public schools, fair kiosks, bakeries, pizzerias, and common consumers all have a need for their pizza, pie, or cake to be cut into even slices. There exists a variety cutters and slicers that result in desired equally-sliced foodstuff.

U.S. Pat. No. 9,259,847 is a cake slicing device that is comprised of three main parts; a cutter, a holder, and a holder tray. This device has a center hollow cut out comprising a holder lip that attaches to the holder tray, wherein the cutter comprises a plurality of non-detachable slicing arms and a blade stabilizing circle, wherein the blade stabilizer is ventrally attached to the non-detachable slicing arms. The stabilizing circle comprises a dorsal face with a radial edge that attaches to a hollow lip of the holder. Manual force must be transmittable from the user's hand to the holder/handle.

U.S. Pat. No. 5,446,965 is a cake slicer and divider the comprises of a core with a plurality of detachable arms that radially project from the core. The core includes slots to support the arms, wherein each arm is an elongated planar member with a ventral edge for cutting. The hand pressure of the user must be applied to the core to ensure a downward force on the cake slicer causing the ventral side of the blades to cut and divide the actual cake.

U.S. Pat. No. 6,557,260 is a pizza cutting device that allows uniform equally-sized slices. The cutting device comprises of a circular frame with a series of non-detachable blades radially spanning across a hollow interior diameter. The cutting device comprises of a pair of handles that requires the user to apply hand pressure to cut the pizza uniformly.

U.S. Pat. No. 4,100,676 is a pizza cutting device that comprises of a base having a pair of oppositely facing flat surfaces with a plurality of slots that act as a cutting guide. These slots intersect to subdivide the surface into a plurality of segments, wherein the segments may be pie-shaped, square, or of the like. A cutting instrument must be used to cut the flat object, such as a pizza, placed on the base.

U.S. Pat. No. 4,250,618 is a pizza cutter that comprises of a plunger that is mounted for vertical reciprocation within a guard sleeve near an open spider fixed to the sleeve to expose the mounted cutter for cleaning. The cutter includes a plurality of radially extending blades that are detachable except when they are held in place by the sleeve. The sleeve connects the blades by the outer edges and limits the size of the pizza which can be cut. A force must be applied to the plunger for the blades to cut the pizza.

### SUMMARY OF INVENTION

The invention is a multifunctional cutter that facilitates easy cutting of pizzas, pies, and cakes. The invention consists of the first level being a circular metal frame that has a series of metal spanning radially across the hollow interior diameter that supports the second level, which consists of a plastic frame with a series of plastic wedge slots that radially span within the hollow interior diameter. The invention also consists of supporting poles that are used to stand the assembly upright and has springs around the lower half which allow the cutter to retract.

It is an object of the invention to provide uniform equally-sized slices on a consistent basis

It is an object of the invention to comprise of a blade cover, cutting guide, two poles, two springs and slicer platform with bearing slots on the ventral side, and is placed within the slicer base.

It is another object of the invention to comprise of a slicer base including cut markers to assist with additional slices.

### BRIEF DESCRIPTION OF DRAWINGS

The preferred embodiments of the present invention with reference to the accompanied drawings and further detailed description in which:

FIG. 1 is an isometric view of the multifunctional cutter assembled together with the pizza blades inserted;

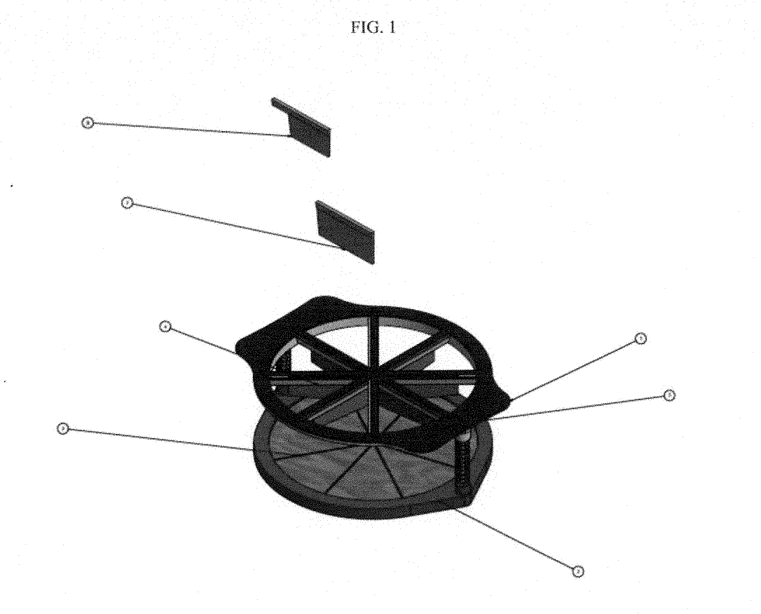

FIG. 2 is an isometric view of the multifunctional cutter dispersed into separate pieces, according to the preferred embodiment of the present invention;

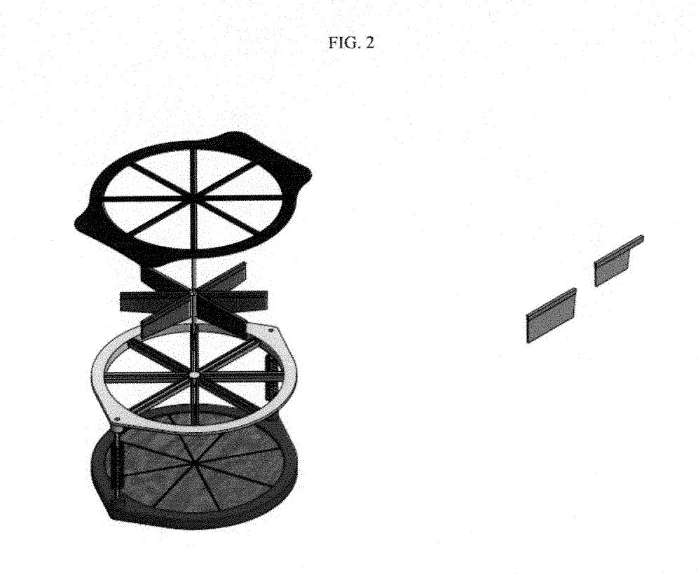

FIG. 3 comprises of multiple views of the circular blade cover, according to the preferred embodiment of the present invention;

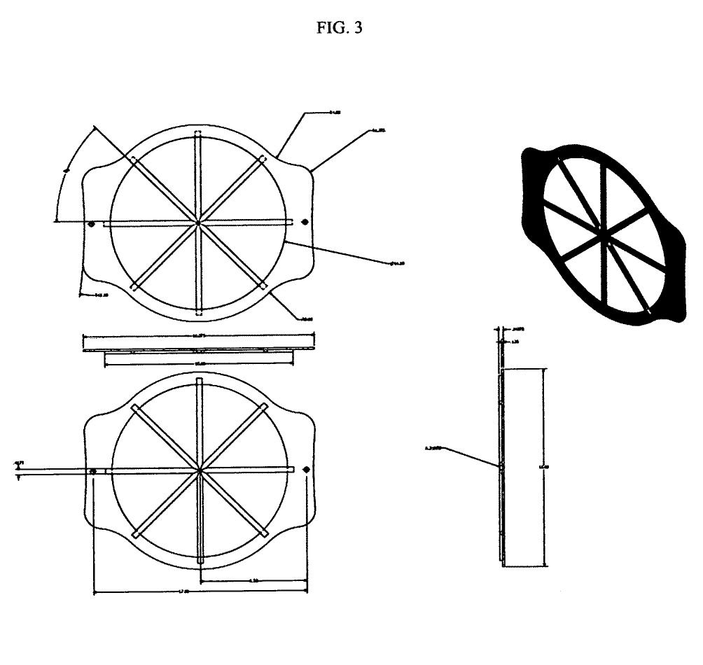

FIG. 4 comprises of multiple views of the circular slicer platform, according to the preferred embodiment of the present invention;

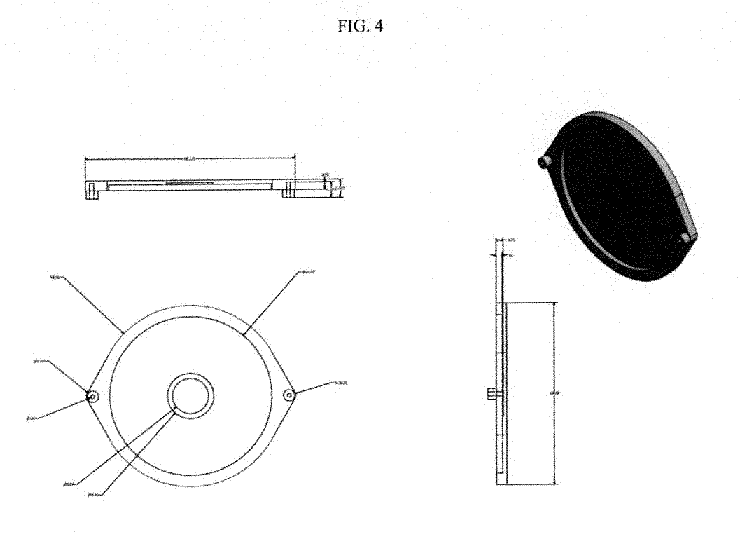

FIG. 5 comprises of multiple views of the circular slicer base, according to the preferred embodiment of the present invention;

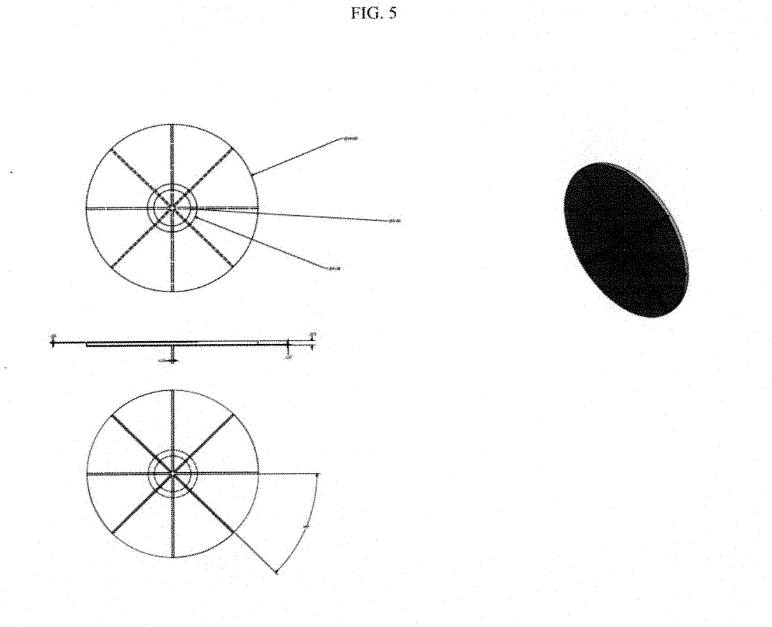

FIG. 6 comprises of multiple views of the circular cutting guide, according to the preferred embodiment of the present invention;

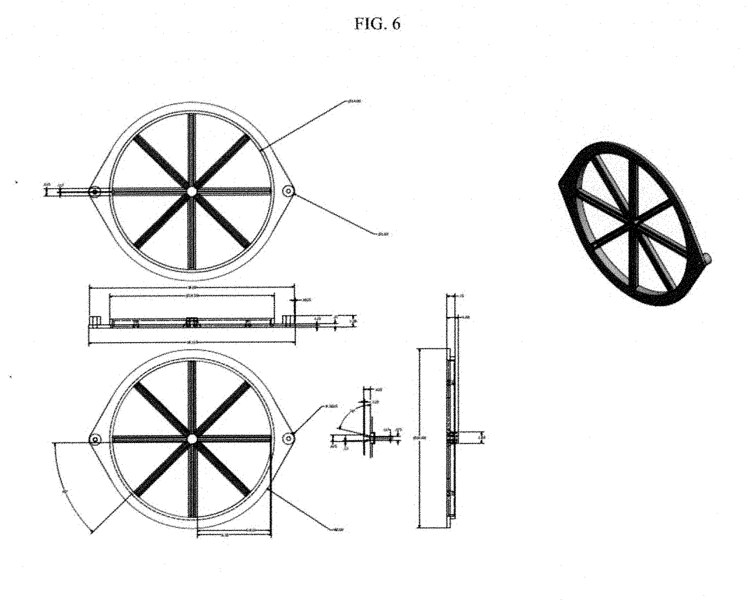

FIG. 7 comprises of multiple views of the pizza blade, according to the preferred embodiment of the present invention;

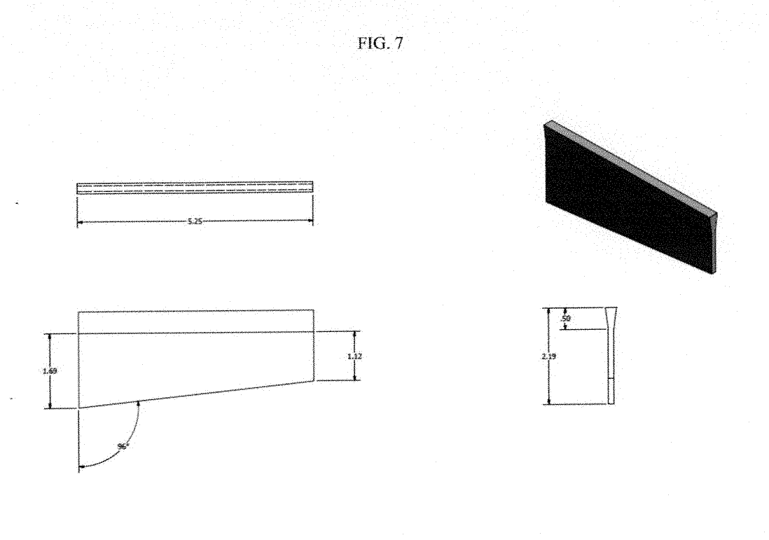

FIG. 8 comprises of multiple views of the pie blade, according to the preferred embodiment of the present invention;

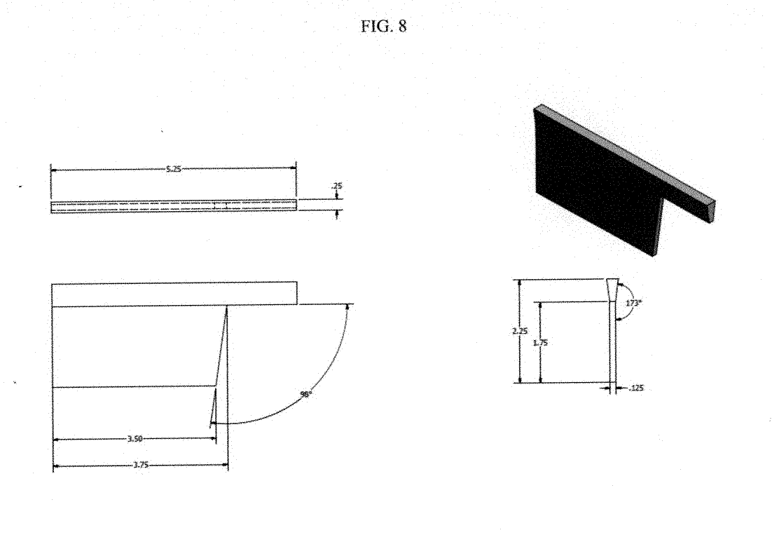

FIG. 9 comprises of multiple views of the cake blade, according to the preferred embodiment of the present invention;

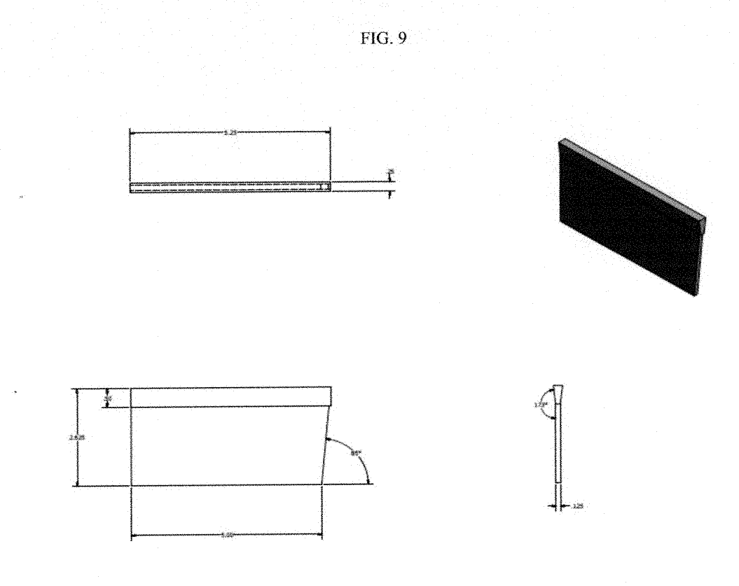

FIG. 10 comprises of multiple views of the guide pole, according to the preferred embodiment of the present invention;

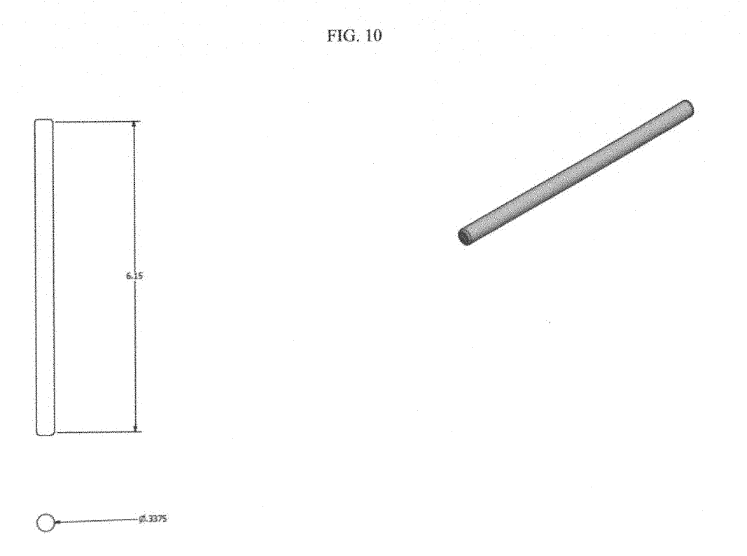

### DETAILED DESCRIPTION OF DRAWINGS

The multifunctional cutter in accordance to the preferred embodiment is comprised of nine main components: a circular blade cover 1, the circular slicer base 2, the circular slicer platform 3, the slicer subassembly 4, the pole 5, the spring 6, the cake blade 7, and the pie blade. The circular blade cover comprises of a pair of handles with holes in the middle of them for poles 5 to slide in between the holes.

The slicer subassembly 4 comprises of the pizza blade and the circular cutting guide. The circular cutting guide within the subassembly 4 comprises of slots for the pizza blade 4, cake blade 7, and pie blade 8 to fit snugly within the slots for accurate cutting. The blades are interchangeable and must be swapped depending on the cutting preference. To ensure the blades do not come out, the circular blade cover 1 holds them in place when assembled correctly.

The circular slicer platform 3 comprises of cutting markers that allow the pizza blade 4, the cake blade 7, and the pie blade 8 to cut thoroughly. The circular slicer platform 3 also sits in the circular slice base 2 and can rotate due to the bearing slots between the circular slicer base 2 and the circular slicer platform 3. The circular slicer base comprises a pair of pegs that supports the poles 5 which then goes through holes of each platform. The springs 6 are placed on poles 5 prior to assembly of the circular slicer platform 3 but after poles 5 are placed in the pegs.

The order of assembly of the multifunctional cutter in accordance to the preferred embodiment from bottom to top is: the circular slicer base 2, followed by the circular slicer platform 3, followed by the poles 5, followed by the springs 6, followed by the cutting guide 4, followed by the blades, followed by the circular blade cover, and lastly pins are inserted into the poles.

What is claimed is:

1. A multifunctional cutter designed to cut uniform equally-sized slices comprising: a circular blade cover frame, a circular cutting guide frame, a circular slicer platform, a circular slicer base, pie blades, cake blades, pizza blades, and pairs of blade wedges, wherein said a circular blade cover frame additionally comprising a pair of handles with central holes and a plurality of non-detachable plastic tracts spanning across a hollow interior diameter, wherein said a circular cutting guide frame additionally comprising a pair of holes corresponding to the blade cover handles and a radial dorsal plastic tract and ventral slots to attach to blade wedges which interlock a plurality of detachable pizza, pie, or cake blades spanning across a hollow interior diameter, wherein said a circular slicer platform additionally comprising a flat wooden base with a plurality of cutting slots of equal distribution on the surface that pass through a centrally located point and is placed within the circular slicer base which comprises of a pair of pegs that extend vertically which corresponds to the blade cover frame and the cutting guide frame and within the core of the circular slicer base is an even smaller circle that indents within the base which allows the slicer platform to act as rotary turntable, wherein the slicer base rotates to create additional smaller equal slices.

2. The multifunctional cutter of claim 1, wherein the circular cutting guide ventral slots attach to the blade wedges allowing the blade wedges to separate and reconnect which results in the replacement the blades.

3. The multifunctional cutter of claim 1, wherein the circular blade cover frame, the circular cutting guide frame, and the circular slicer base are connected by a pair of elongated poles, with an open-ended bottom and closed-ended top and two holes for metal pins near the top, starting from the pegs on the circular slicer base that extends through the circular blade cover.

4. The multifunctional cutter of claim 3, wherein the bottom half of the elongated poles between the circular cutting guide frame and the circular slicer base are supported by a pair of springs, wherein the pair of springs allow the circular cutting guide frame and the circular blade cover frame to retract.
